(19) United States
(12) Patent Application Publication
(10) Pub. No.: US 2014/0286048 A1
(43) Pub. Date: Sep. 25, 2014

(54) SWITCHABLE LUMINESCENT SEE-THROUGH SYSTEM

(71) Applicant: Heliv Group Srl., Venezia (IT)

(72) Inventors: Pietro Riello, Padova (IT); Francesco Enrichi, Venezia (IT); Luca Bellotto, Treviso (IT); Isidora Freris, Venezia (IT); Simone Bellan, Padovana (IT)

(21) Appl. No.: 14/357,414

(22) PCT Filed: Nov. 10, 2012
(86) PCT No.: PCT/IB2012/056318

§ 371 Date: May 9, 2014

(30) Foreign Application Priority Data
Nov. 11, 2011 (IT) ITVE2011A000074

(51) Int. Cl. G09F 13/18; F21V 8/00; G09F 13/20; F21V 9/00

(52) U.S. Cl. CPC G09F 13/18; F21V 9/00; G02B 6/0035; G02B 6/0028; G09F 13/20
USPC 362/608; 362/84; 362/627; 362/616; 362/582; 362/559

(57) ABSTRACT

The present invention relates to a switchable see-through luminescent system, e.g. for luminous signage, characterized by its mode to exist in two different states, transparent (‘off-state’) and luminescent (‘on-state’), due to the presence of a luminescent material (20), coated on to the transparent surface (10), capable of being excited on command by means of lighting sources (30) (e.g. LEDs) characterized by suitable emission spectra. In the off-state of the luminescent material (20), the surface appears transparent and it is not evident any significant modifications of the optical properties (transparency, color, etc.) of the surface. The excitable luminescent material, from which a large variety of luminophores can be conveniently applied on to a substantially transparent support, of arbitrary geometry, realized with a plurality of homogenous and heterogeneous materials, including laminated glass or double glazed windows, provides a large variety of possible shapes capable of satisfying varied application requirements.

### TECHNICAL FIELD

The present invention relates to an excitable switchable see-through luminescent system that can be applied on a transparent support base, such as a shop window, for visualization on command of luminescent graphic elements once these have been effectively excited by a suitable source of electromagnetic radiation. The said system is, for example, applicable in the field of signage, publicity, visual communication, furniture and lighting.

### BACKGROUND ART

The problem of modifying a transparent body to obtain a diffused light sources has been addressed in a variety of ways. According to the current state of the art, it is possible to use different solutions to illuminate plastic or other materials by exploiting the phenomenon of luminescence or fluorescence produced by opportunely excited chemical compounds, typically from light radiation generated by LEDs. In general terms, the solutions known in the art can be divided in two broad categories.

A first kind is represented by the use of different fluorescent formulations, paints or dyes, that have been proposed for rendering luminescent the surfaces of transparent materials such as plastic or glass. Notwithstanding varying solutions of these being known in the current state of the art, they are of limited application on transparent surfaces, as the matrix in which the dyes of luminophore agents are dissolved, present a milky or yellowed background appearance in their off-state when excitation is absent.

A second kind encompasses solutions for rendering materials such as plastic luminescent by means of mass incorporation of pigments or opportune luminophore agents. Such a formulation allows for the realization of plates or items in plastic to be structured in any form, typically by injection moulding. Nevertheless, luminescent materials realized in this way have limited application flexibility as decorative elements, since they cannot be applied to already mounted structures such as shop windows, given that it is not possible to inject the radiation of light generated from the source with a suitable angle, in an efficient mode to generate adequate luminescence. To compensate for this problem, several alternative proposals based on various configurations for the light source's propagation have been given.

In the years many patents of the first kind have been filed to cover, with several formulations or arrangements, a variety of applications such as framed display, backlighted device for image display or signage advertising. Generally, these applications known in the art require high contrast and light intensity that are usually achieved by including in the system mirrored surfaces or scattering agents (e.g. powders such as silica, white or colored pigments, machined scratching, laser engraving). Amongst all the solutions encompassing light sources, methods for propagation of luminous radiation and visual systems, the configuration known as ‘edge-light’ is of particular significance. In fact, in this configuration, the light is injected into the transparent material, generally in the form of a flat or curved plate, from its edge so that it is propagated inside the material guided from the surface of the same. The phenomenon is derived from the total reflection of radiation at the interface between the transparent material (with refractive index nt) and air (refractive index na<nt). Many patents use this ‘edge-light’ configuration of illumination (with LED or other light sources). For example, WO2008153528 and US20070124970 describe, respectively, an ‘edge-light’ display encompassing a diffusing layer (for scattering) and a reflecting layer positioned at the back and always in an edge-light configuration; it exploits the radiation propagated inside the material, although it does not consider the utilization of the phenomenon of luminescence.

For instance US patent 2009/0100727 describes a structure of shining signboard, having LEDs that are fitted into grooves of a transparent plate such that light emission angle of LED light source is projected in parallel to transparent plate. The main object of this invention is to provide a LED signboard which enhances the advertising or signally visual effects. The sign can be a design, notice, graphic devises, blurb etc or their combination, and it is formed in the front or back wall of the base panel by means of laser engraving, CNC etching, ink printing, fluorescent substance printing or writing or drawing. According to US 2009/0100727, the sign is enhanced under LEDs light irradiation (‘on-state’) and therefore the sign is visible even when the LEDs are off (‘off-state’). The physical mechanism which makes visualization possible is light scattering i.e., surface engraving and etching. Noticeably, the LED light set represents an integral element of the signboard as the inventor claims that LEDs are mounted internally within a groove of the transparent base. This arrangement represents a serious drawback in many applications, for instance where large or geometrically complex surfaces are required to present the signally visual effect, and the LED light, or other suitable light source, has to be physically separated from said surfaces. The complete LED signboard according to this invention, is not transparent as it comprises a back plate or a rear mirrored finish in all embodiments. In addition, this patent describes, but does not claim, a design of a fluorescent substance and no mention of LED light wavelength (or reference to excitation wavelength of fluorescent substances) is provided. Moreover, fluorescent substances are not specified nor is an optical relationship described with respect to LED sources. Finally, emission of color is given as a function of LED color rather than optical emission from fluorescent substance. It is clearly evident to the skilled in the art that the main scope of the inventor is to realize a suitable arrangements for a LED set in a non-transparent (i.e. see-through is not possible) framed signboard comprising a mirror finish in the back-panel and to generate different colors for the signboard only by selecting suitable LEDs devices (and not selecting a fluorescent substances).

A second patent, U.S. Pat. No. 5,546,687, discloses a framed backlighted image display device that requires a mirror coating applied to a polished back surface of an acrylic transparent optical sheet material. Said sheet material has a ground front surface carrying a layer of fluorescent paint. The scope of the invention is displaying an illuminated image in a frame as the invention is intended for creating an object with a suitable size for wall hanging or placement on a desk. Light passes through an edge of the panel to the ground surface where it is diffused and amplified by the fluorescent layer. Particularly, the (front) fluorescent paint layer is herein used as a light intensifier in combination with the (front) ground surface and mirrored back. Basically, edge-light is converted to back-light for visualization of a photo. Again, a light diffusion mechanism is required and enhanced to increase visibility of a printed CIBACHROME image illuminated from behind. Noticeably, the CIBACHROME transparency is also visible in the absence of back-light which is placed in front of the fluorescent paint layer. This solution known to the state of the art, despite allowing an elevated flexibility of realizable shapes is not applicable on already mounted structures, e.g. shop windows, as such that the luminophore agents are dispersed in the body of the material, a condition which limits the transparent material to being that of plastic. In addition, the fluorescent paints cited (i.e. STROBLITE, UV BLACKLIGHT Tempera Paint, Invisible Blue). are not transparent and are visibly white under normal lighting conditions. Finally this patent claims a display that is made up of numerous layers and does not present an overall transparency (i.e. see-through is not possible).

The invention disclosed in JP2000276084 resembles some features of the aforementioned patents. It describes a light-emitting display apparatus used for e.g. advertisement characterized by a light-emitting element arranged to the upper end of a display body for illuminating a display pattern printed on a transparent plate. This patent is intended to enhance contrast and brightness luminance of the display pattern to prior display apparata. The view paint is composed by a mixture of white and colored pigments in a matrix permeable to light that is applied on the back of a transparent support. The characters and images to be displayed are printed on the body of the display. By means of a ‘edge-light’ arrangement, the light, guided to the interior of the display body, irradiates the luminous paint and the graphic sign to be displayed is accentuated visually. To further enhance characters and images brightness, a reflecting film is positioned or a reflective paint is applied on the surface opposite to that of the light source. Ii is clearly evident to the skilled in the art that the main scope of the inventor is to enhance contrast and brightness luminance of the display by means of a coating material composed of white and color pigments and a white reflecting plate applied on the back side of the display body. Therefore the assembly for the display apparatus according to JP2000276084 do not present an overall transparency and seeing-through said display apparatus is not possible. In addition, the sign or graphic devises is clearly visible under normal lighting condition (‘off-state’).

Other patents disclose several formulations for a luminescent paint and its application on a luminous panel used mostly for the purpose of advertising.

For instance, the Japanese patent JP2000276084 is primarily focused on varnish preparation, specific parameters for its reticulation, methodology for its coating on a transparent support, and stability testing. This invention describes a luminescent coating material based on a trifunctional silicon alkoxide containing an ureido group, a luminescent pigment and a high boiling point solvent. One of the main intent of this patent is to provide a luminous paint with elevated mechanical resistance to prior formulations. The use of the luminescent coating material according to the patent JP2000276084 enhances adhesion to the transparent base material, coating film hardness, film strength, chemical resistance and therefore durability of the luminous film. No protective top-coat is required (e.g. such as Vapor Deposition coatings). According to this patent, the luminescent coating material can be easily patterned by printing. However, it requires specific coater or facilities and only certain transparent base materials can be coated with the claimed paint formulation as the enhancement of the mechanical adhesion to the base requires a high-temperature treatment (in the range 150 e 300 degree C.) not suitable for application on polymeric transparent surfaces (e.g. a methacrylate partition) nor on already mounted structures (e.g. a shop windows). Noticeably, it is clearly out of the scope of the present invention to obtain a luminescent material characterized by transparency as in one embodiment visibly colored pigments (e.g. Rhodamine 6G) under normal light conditions are used (in elevated concentration, 1-50% wt.); another embodiment describes the use of a varnish containing 1-20% powdered silica (50 μm particle diameter) to increase mechanical resistance (unfortunately powdered silica increase light scattering and it is detrimental for transparency).

An alternative technical solution to the aforementioned, worthy of mention, was proposed in the document U.S. Pat. No. 6,584,714 ‘Fluorescent Structured shaped bodies’ in the name of Wehrmann et al., in which an optical display was described which encompasses shaped articles molded from transparent or semi-transparent plastic materials. The solution described in patent U.S. Pat. No. 6,584,714, despite representing progress in the state of the art, presents some drawbacks here forth reported. Firstly, the material described is characterized by the presence of centers for scattering in order to favor a mechanism of display/light exit based on diffusion of the illuminating radiation. Secondly, the luminescent materials are ‘shaped articles’ designed to promote the propagation of the light beam. This solution, despite allowing an elevated flexibility of realizable shapes, is not applicable on existing structures, e.g. shop windows, as such that the luminophore agents are dispersed in the body of the material, a condition which limits the application to polymeric transparent materials.

### DISCLOSURE OF INVENTION

### Technical Problem

It is clear to the skilled in the art that the teachings of the aforementioned known solutions present several drawbacks which make not feasible a switchable luminescent system characterized by its mode to exist in two different states, transparent (‘off-state’) and luminescent (‘on-state’) and where the switchable luminescent system in the off-state appears transparent like any other standard transparent surface. In many applications (e.g. in the field of signage, publicity, visual communication, furniture and lighting) this feature would be desirable and would allow for a double function of the same transparent surface according to the specific needs at a certain time. In other words, the surface of a product (e.g. a shop windows) exhibits luminescence in the on-state (first function), while it looks like any standard see-through surface (second function) without visible coatings or graphics in the off-state. A first drawback of the disclosure known In the art is that they cannot be applied to already mounted structures such as shop windows for visualization on command of luminescent graphic elements once these have been effectively excited by a light source.

In addition, the luminescent system known in the art under normal light conditions are not transparent (i.e. see-through is not possible) because of arrangements or formulation comprising white or colored powders, machined scratches or engravings, diffusing or mirrored surfaces which enhance light absorption or light scattering in the visible range. Finally, the luminescent coating material in the luminescent system cannot easily removed from the base material on which they are applied.

To overcome the aforementioned drawbacks of the prior art, a novel switchable luminescent see-through system is disclosed.

### SOLUTION TO PROBLEM

### Technical Solution

It is a primary objective of the present invention to realize a switchable see-through luminescent system excitable on command, by means of a suitable light source, allowing the visualization of luminescent graphics from transparent surfaces.

Within the framework of the principal objective, an additional important aim of the present invention is the realization of a switchable luminescent system that exhibits transparency in its off-state (non-excited conditions) and exhibits itself luminous in the on-state once activated by the radiation emitted by a source of excitation. In the off-state of the luminescent material, the surface appears transparent and it is not evident any significant modifications of the optical properties (transparency, color, etc.) of the surface.

Within the framework of the primary objective, an additional important aim of the present invention is the realization of a switchable see-through luminescent system that in its on-state (excited conditions) is capable of exhibiting various colors, also simultaneously, or on different areas by being selectively activated.

In particular, within the framework of the primary objective, an additional important aim of the present invention is the realization of a switchable see-through luminescent system capable of effecting dynamic communication, adjustable in accordance with the setting in which the said system is positioned.

Additionally, within the framework of the primary objective, an additional important aim of the present invention is the realization of a switchable see-through luminescent system in which the transparency in the non-excited state (off-state) is not deteriorated by mechanisms of visible light diffusion due to the intrinsic material properties or due to intentional modification of the same material.

Additionally, within the framework of the primary objective, an additional important aim of the present invention is the realization of a switchable see-through luminescent system in which, under excited conditions (on-state), the light is guided only by the transparent body that supports the see-through luminescent system and not from the matrix in which the luminophores are dispersed.

Within the framework of the primary objective, an additional important aim of the present invention is the realization of a switchable see-through luminescent system that is easily applied on any transparent body or semi-transparent body, including laminated glass and double glazed glass systems.

An additional primary objective of the present invention is the realization of a switchable see-through luminescent system that is compatible with a large variety of organic and/or inorganic luminescent or fluorescent substances.

Additionally, a further important objective of the present invention is to realize a switchable see-through luminescent system capable of being applied on transparent surfaces of structures even when they are already installed.

Within the framework of the primary objective, an additional primary aim of the present invention is the realization of a switchable see-through luminescent system that can be easily removed from the material or structure on which it is applied.

Finally, an objective of the present invention is the realization of an excitable switchable see-through luminescent system, preferably by means of a light source, and developing a method for the realization of luminescent graphics on transparent surfaces by means of known technologies.

These and additional objectives, which become apparent hereafter, are achieved by the inventor with a two state switchable luminescent system, particularly for luminous signage, characterized in that it is transparent in the off-state and is luminescent in the on-state and comprises: a transparent supporting means of arbitrary shape; a luminescent material applied or coated on to the surface of said transparent means; single or multiple excitation sources capable of generating electromagnetic radiation with a spectrum suitable for activating the said luminescent substances and permits the transition of the said switchable see-through luminescent system from an off-state to an on-state.

### ADVANTAGEOUS EFFECTS OF INVENTION

### Advantageous Effects

It is apparent to those skilled in the art that the invention as described allows for the realization of the intended objectives and advantageous effects. In particular, the present invention discloses a switchable see-through luminescent system with two states that can be activated on command, by means of a variety of electromagnetic radiation sources with suitable spectra, so as to visualize luminescent graphics on transparent surfaces in the excited state, and appear completely transparent in the non-excited state.

In addition, the present invention discloses a switchable see-through luminescent system that presents a high level of transparency under non-excited conditions provided that the luminescent material is conveniently selected. In particular, to avoid light scattering, particles in the composition of the luminescent material must have size that do not significantly induce the diffusion of visible light, as in the case of nanophosphors (or quantum dots), and to avoid a visible coloring of the switchable luminescent system in the off-state, the absorption spectrum of said luminescent or fluorescent material in the visible region must be as low as possible. Additionally, during the mode of excitation the propagation of light inside the support does not exploit mechanisms of visible light diffusion, therefore allowing the emission of light from the system to achieve one of the main objective of the invention. Furthermore, the present invention discloses a switchable see-through luminescent system in which, during excitation, the light is guided exclusively by the support material and not by the matrix in which the luminophore agents are dispersed. Additionally, the present invention discloses a switchable see-through luminescent system which can be applied on the transparent surfaces of materials already installed. In fact, the possibility to inject the excitation beam by means of a wedge combined with the surface of the support, can impart luminescent properties to existing structures, such as shop windows, without the need for their disassembly. Finally, the present invention discloses a switchable see-through luminescent system which displays various colors under excited state conditions, as a function of the luminescent material's formulation. In addition, it is possible to create a support for which different zones of the surface exhibit different colors. Since these zones can be activated selectively, with the present invention a flexible visualization system is conceived, that can actuate forms of dynamic communication and be adapted accordingly for the contest in which the said system is placed.

### BRIEF DESCRIPTION OF DRAWINGS

### Description of Drawings

Additional features and advantages of the present invention will be apparent from the following description of preferred embodiments, made by way of an indicative non-limiting example with reference to the annexed drawings wherein:

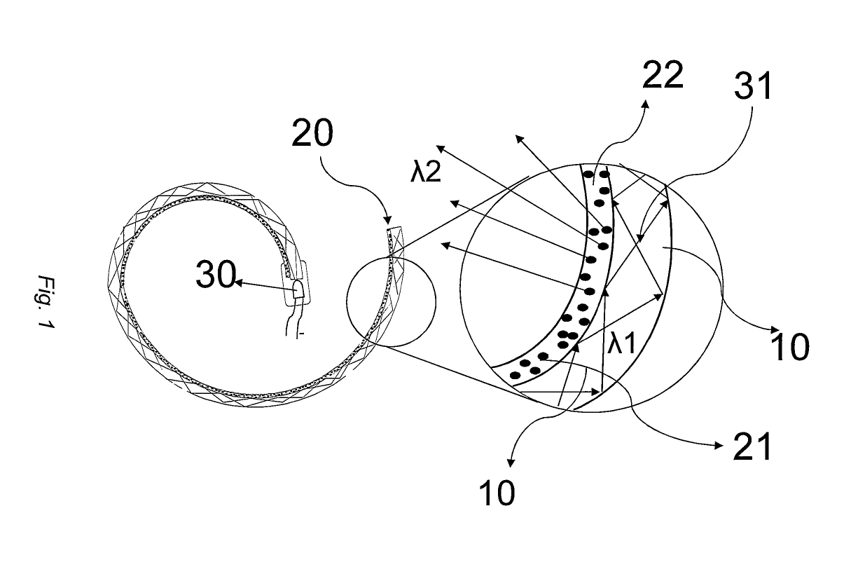

FIG. 1 shows, with the letter (a) a general top view of the switchable see-through luminescent system according to a first embodiment of the present invention , comprising a transparent means of arbitrary shape, while the letter (b) shows an enlargement of the said system evidencing the luminophore elements;

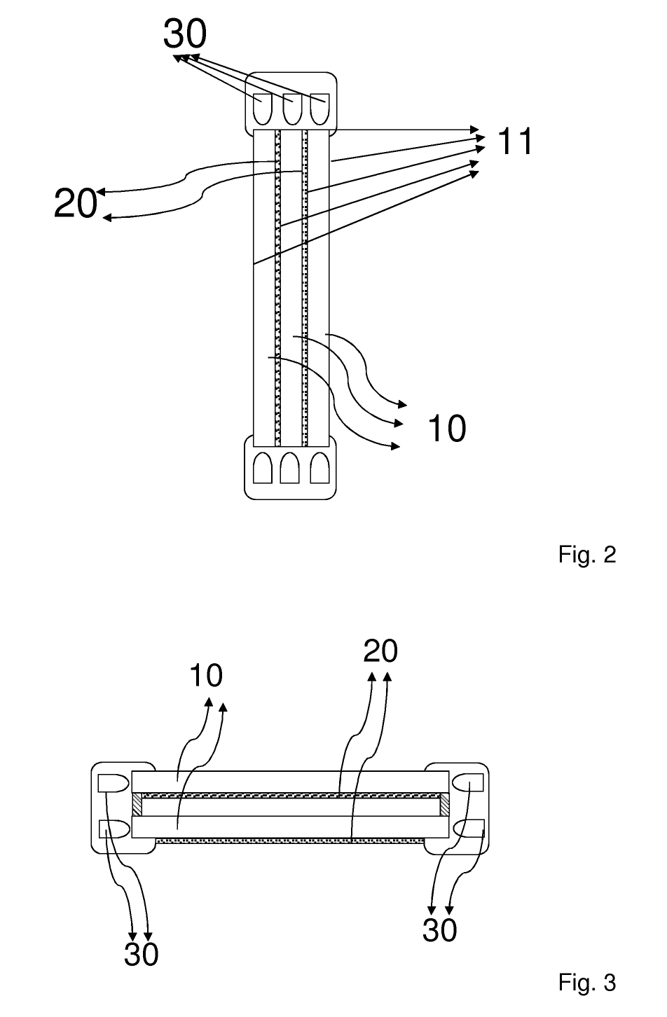

FIG. 2 shows a perspective view of the switchable see-through luminescent system, according to a second embodiment of the present invention, for which the panel (a) appears transparent when in the off-state, while the letter (b) evidences a luminescent image or writing in the on-state when excited by a light source;

FIG. 3 shows a general top view of the switchable see-through luminescent system, according to a third embodiment of the present invention, represented by laminated glass having transparent layers which luminesce under excitation conditions using the configuration known as ‘edge light injection’;

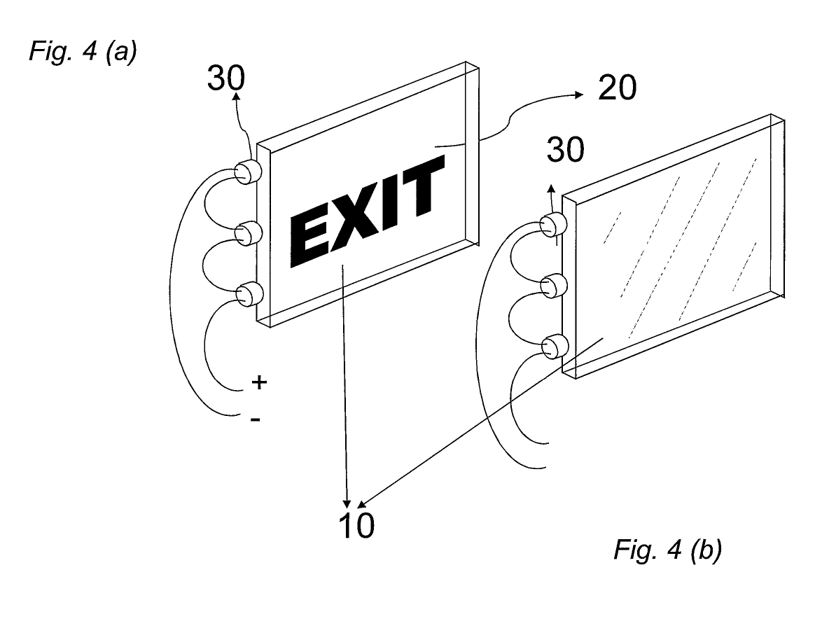

FIG. 4 shows a general top view of the switchable see-through luminescent system according to a fourth embodiment of the present invention, represented by double glazed glass unit in which the internal surfaces are covered with a transparent coating which luminesce under excitation conditions using the configuration known as ‘edge light injection’;

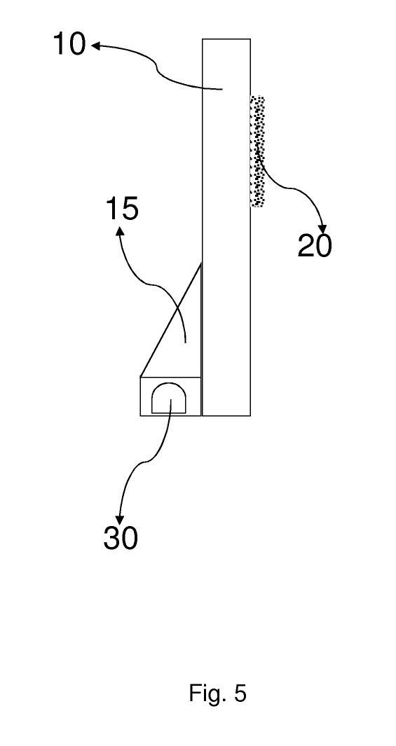

FIG. 5 shows a general top view of the switchable see-through luminescent system, according to a fifth embodiment of the present invention, represented by double glazed glass unit having transparent coatings which luminesce under excitation conditions using the configuration ‘side light injection’.

### BEST MODE FOR CARRYING OUT THE INVENTION

### Best Mode

With reference to the above cited figures, a switchable see-through luminescent system according to the present invention, characterized by the fact that it presents itself in two states, transparent in its ‘off-state’ and luminescent in its ‘on-state’ in accord with the presence or absence of suitable excitation is indicated in a first embodiment with the number (1). Such switchable luminescent system (1) comprises support means (10) having an arbitrary shape delimited with one or more surfaces (11). As an indicative non-limiting example of the present invention, the said support means (10) is essentially realized with transparent materials, preferably glass, quartz crystal, glass ceramics, transparent or semi-transparent plastics such as poly(methyl methacrylate), polycarbonate, polyvinyl butyral or combinations of these. These materials, depending on the case, can be treated by means of tempering, coating or other current state-of-the-art processes to adapt their mechanical and optical properties for their intended use. In addition, these materials may be joined together, for example by lamination or bonding, using methods known to those skilled in the art to realize complex geometries with heterogeneous materials, preferably in a heterogeneous laminated or double glazed system. In any case, the said support means (10) appears substantially transparent under visible light, as such that any eventual diffusion of light is caused exclusively by the presence of impurities, air bubbles, crystallization, scratches or other intrinsic non-homogeneous factors introduced unintentionally.

In the first embodiment of the present invention, intended as an example and not limited to, a luminescent material (20) is coated on to one or more areas of the surface (11) delimited by the transparent support (10). The said luminescent material comprises one or more luminescent or fluorescent substances (21) having different absorbance and emission spectra. Advantageously, as an example for the current invention, but not limited to, the said luminescent or fluorescent substances (21) are preferably phosphors, nanoparticles, quantum dots, transition metal complexes or other organic and inorganic luminophore agents known to experts in the field.

According to the primary objective of the present invention, the absorption spectrum of said luminescent or fluorescent material has to fulfill two basic requirements: firstly, the absorption spectrum in the visible region has to be as low as possible in order to avoid light absorption by the luminescent coating and therefore a visible coloring of the switchable see-through luminescent system in the off-state; secondly, the absorption spectrum in the near UV region has to be as high as possible in order to enhance the exciting light absorption by the luminescent or fluorescent substances and therefore the emission of visible and colored light by the switchable see-through luminescent system in the on-state. Advantageously, such luminescent or fluorescent substances (21) are preferably dispersed in a transparent matrix (22), being organic, inorganic or hybrid based, as an example only and not limited to, polymeric matrices, resins, and matrices based on silica and its composites. Depending on the intended formulation of the matrix (22), and using techniques known to those skilled in the art, the luminescent or fluorescent substances (21) may be incorporated in varnish or ink, polymeric layers, or plastic adhesive films. In addition, the said luminescent or fluorescent substances (21) may be applied on a plurality of areas on the surface (11) of the support means (10) by using a large variety of state-of-the-art techniques. In the case of a formulation matrix (22) which is predominately constituted by a varnish or ink, such coating techniques may include the following indicative non-limiting examples, rotary printing, offset printing, rotogravure printing, spray painting, flexography, pad printing, screen printing, ink-jet printing, laser printing, additive manufacturing, heat transfer and lenticular printing. In the case where the formulation matrix (22) is an inorganic coating, such as a SiO₂ or TiO₂ film, then the following examples of deposition techniques may be applied without being limited to, CVD, PECVD, MOCVD, dip-coating, roll-coating, spin-coating, air-knife coating and spray-pyrolysis. Alternatively, such luminescent or fluorescent substances (21) may be applied in the said areas of the surface (11) in their pure or powdered form by the following methods without being limited to, powder coating, dry-offset printing, xerography (or electrophotography), and other equivalent techniques based on dry printing by electrostatic interaction. In the first embodiment of the present invention, intended as an example without being limited to, the said switchable see-through luminescent system (1) comprises one or more sources of excitation (30), with the objective of allowing a transition to occur between the transparent state (the off-state) and the luminescent state (the on-state) or vice-versa. For illustrative purposes, without being limited to, the said plurality of sources for excitation (30) are preferably LED, laser, neon lighting, gas-discharge lamps, other multi-beam or diffuse luminous sources, or a suitable combination of these opportunely powered by a voltage transformer and a programmable controller, or similar electrical or electronic apparatus. In addition, in accordance with the formulation matrix (22), and the application of the switchable see-through luminescent system (1) according to the present invention, the emission spectrum of each excitation source (30) will be advantageously chosen for its compatibility with the luminescent or fluorescent substances (21) in the said matrix (20) in order to induce absorption and stimulate fluorescence, phosphorescence or other processes of luminescence arising from the luminescent material (20). For illustrative purposes, without being limited to, the said excitation spectrum (continuous or discrete), preferably overlaps the high-energy tail of the visible spectrum (or the near UV region) with an excitation wavelength (1₁) of said radiation lower that of the emission wavelength (1₂), as determined from the excitation spectrum of the luminescent or fluorescent substances (21). A LED light source with an emission close to the lower wavelength of the visible spectrum (e.g. 380-400 nm) can be advantageously used. With the objective of increasing the efficiency of the said luminescent processes, the switchable see-through luminescent system (1) may include reflective films, concentrators or other equivalent technical devices known to those skilled in the field, provided that in the ‘off-state’ such devices do not restrict the transparency of the support (10). In order that a plurality of sources (30) would be capable of exciting the luminescent or fluorescent substances (21) contained internally within the luminescent material (20) (and allow the transition of said switchable see-through luminescent system from ‘off-state’ to ‘on state’), the luminous radiation (31) must be conveniently injected in to the transparent support (10). In the first embodiment of the present invention, intended as an example without being limited to, the configuration named ‘edge light injection’, laterally injects electromagnetic radiation (31) in the transparent support (10) directly from the edge (13). Once injected, the electromagnetic radiation (31) generated from the luminous sources (30) propagates in such mode so that it is guided inwards of the said transparent support (10), as schematically shown in FIG. 1. Advantageously, designing a convenient geometry for the transparent support (10), the electromagnetic radiation (31) can reach and excite the luminescent or fluorescent substances (21) coated on one or more areas on the surface (11) of the said transparent support (10). Part of the visible radiation generated in an isotropic manner from the said luminescent or fluorescent substances (21) hits the surface of the luminescent material (20) with an angle that causes colored emission to exit from the switchable luminescent system (1) on a portion of the surface (11) on which the said material (20) is applied. Once the switchable luminescent system (1), according to the present invention, it is intended to guarantee an high transparency in its ‘off-state’ (i.e. no significant modifications of the optical properties of the surface), it is necessary to avoid any modifications on the material and the surface (11) that would generate the phenomenon of diffusion of visible radiation compatible with the intrinsic characteristics of the transparent materials constituting the support (10) and of those available commercially. In the case of solid phase luminescent compounds being dispersed within the luminescent material (20), the dimensions of such luminescent compounds must be inferior to the wavelength of visible radiation (or rather well below 400 nm) and typically inferior to 50 nm, with the technical restraint being the absolute requirement to eliminate and/or limit as much as possible the process of diffusion/scattering of visible light. Within the luminescent system (1), the transparent support (10), on which the luminescent material (20) is applied, plays the role of light guide, limited to the excitation radiation; this role is not played by said luminescent material (20) which is used solely for dispersing the said luminescent or fluorescent substances (21). In order to guarantee an high efficiency excitation process, the transparent support (10) must be highly transparent to the exciting radiation.

### MODE FOR THE INVENTION

### Mode for Invention

In a second embodiment of the present invention, depicted in FIG. 2 and therein indicated by number (2), the configuration ‘edge light injection’ is schematically shown, where the transparent support (10) would be a flat plate of laminated glass. Such embodiment of the current invention, intended as an indicative non-limiting example, discloses a transparent support (10), in the form of laminated glass where the transparent support, (10) comprising the luminescent material (20) is applied on the surface (11) between a suitable laminating layer. Said luminescent material (20) appears luminescent when advantageously excited by electromagnetic radiation (30). Once the transparent support (10) becomes a luminous source, its transparency is noticeably reduced and/or cancelled.

In a third embodiment of the present invention, depicted in FIG. 3 and therein indicated by number (3), the configuration ‘edge light injection’ is schematically shown, where the transparent support (10) would be a double glazed glass unit. In all embodiments 1, 2 and 3, the coloring is obtained from the particular combination of different luminescent or fluorescent substances (21) with the excitation sources (30) used. Advantageously, the system as it is described in its first three embodiments, illustrating the invention, made by way of an indicative non-limiting example without, is suitable as an architectural element for glass structured facades in buildings, or as illuminating partition walls for open-space offices, as screens for shower boxes and sanitary units or additionally as a system of diffuse lighting, imparting novel functionality by being switchable, for architectural elements and existing transparent furnishings in a given setting.

In a fourth embodiment of the present invention, depicted in FIGS. 4(a) and 4(b), and therein indicated by number (4), the configuration ‘edge light injection’ is schematically shown, where the switchable see-through luminescent system (4) as described is applicable in the field of signage. In particular, if the portions of the surface (11) on which the luminescent material (20) is applied comprises notices or written communication, for example the word ‘EXIT’, according to the present invention, the switchable see-through luminescent system (1) would appear transparent in the ‘off-state’, while in the ‘on-state’ the word ‘EXIT’ would appear colored following excitation by a plurality of sources (30). Advantageously, the luminescent or fluorescent substances (21), can be selected in a way that it is possible to activate the appearance of colored writing on a different colored background during the ‘on-state’. By means of a suitable programmable controller, the excitation sources (30) can be selectively activated to illuminate portions of the surface (11) and momentarily allow for switching between written communication of relevance in a specific environment (for example, signaling of escape routes during high traffic), while leaving transparent any portions of the surface (11) which transmit messages that are misleading or of lower relevance in the same moment (for example, advertising messages).

In a fifth embodiment of the present invention, depicted in FIG. 5 and therein indicated by number (5), the electromagnetic radiation (30) is injected into the transparent support (10) (in FIG. 4 illustrated as a flat sheet/panel) directly from one or more surfaces (11), by means of a transparent wedge (15) that combines the sources (30) directly with the transparent support (10). By suitably sizing the geometry of the said wedge (15), the electromagnetic radiation (30) generated by the sources (31) will be diverted into the interior of the transparent support (10). The wedge (15), preferably composed of transparent plastic with a wedge-shaped profile, includes the LED excitation sources (30) which may be integrated within a frame if necessary. The configuration herein described, intended as indicative non-limiting example of the present invention, is called ‘side light injection’ and conveniently allows for existing transparent structures, such as shop windows, to become a switchable see-through luminescent system (2) according to the present invention without being disassembled.

In many of the embodiments of the present invention herein described, it is possible to use techniques for application of the luminescent material (20) that permit the complete removal of the said luminescent material (20) from portions of the surface (11) on which it is applied. For this purpose, it is possible to use suitable solvents or mechanical removal methods, using techniques known by expert technicians in the field. In this way the switchable see-through luminescent system according to the present invention, can advantageously exploit the realization of temporary (removable) signs, such as those used in shop windows for decoration, communication and advertising.

While the present invention has been particularly shown and described with reference to particular embodiments thereof, it will be understood by those skilled in the art that various changes may be made and equivalents substituted for elements thereof without departing from the broad scope of the invention. In addition, many modifications may be made to adapt a particular situation or material to the teachings of the invention without departing from the essential scope thereof. Therefore, it is intended that the invention not be limited to the particular embodiments disclosed herein, but that the invention will include all embodiments falling within the scope of the appended claims. In practice, the geometry of the support, the shape of the luminescent material, the type of luminophore and the method of coating the transparent support, may be varied accordingly to meet technical requirements provided they are compatible with the specific (intended) use. Where the characteristics and techniques mentioned in the claims are followed by a numerical reference, such references have been allocated solely with the objective of increasing the understandability of the claims. Consequently, such numerical references do not have any limiting effect on the interpretation of each element and are used exclusively as numerical references for their identification.

### INDUSTRIAL APPLICABILITY

It is apparent to those skilled in the art that the invention as described allows for the realization of the intended objectives and industrial applicability. In particular, with the present invention a switchable luminescent system for transparent surfaces has been disclosed that can be produced by using known technologies.

In addition, the present invention discloses a switchable see-through luminescent system that is readily realized in any shape or transparent material as demonstrated in the embodiments given, intended as indicative non-limiting examples of the present invention. In fact, the characteristics of the present invention are the transparency that must be guaranteed after the luminescent or fluorescent substances are included in the luminescent material.

Furthermore, the present invention discloses a switchable see-through luminescent system which can be obtained with a variety of shapes that are capable of satisfying varied application requirements. In fact, the excitable luminescent material, in which a large variety of luminophore agents may be dispersed, can be conveniently coated on any support based on a variety of homogeneous and heterogeneous materials, including laminated glass or units of double glazed glass. In addition, the great availability of excitable luminescent materials, namely organic, inorganic and transition metal complexes, combined with their possible dispersion in a substantially transparent material such as varnish, polymeric or oxide film, renders the switchable see-through luminescent system simple and versatile for application on any transparent or semi-transparent material, including laminated glass or double glazed glass.

Finally, the switchable see-through luminescent system according to the present invention, may be advantageously exploited for the realization of removable signs, such as those used in shop windows for decorative purposes, communication and advertising, as they can be easily removed by use of common solvents or a scraper.

Sequence Listing Free Text

1. A switchable luminescent system characterized in that it is transparent in the off-state and it is luminescent in the on-state and it comprises:
a transparent supporting means (10) having an arbitrary shape and limited by one or more surfaces (11), wherein modifications to said supporting means (10) are not intentionally introduced with the purpose of inducing visible light scattering;
a luminescent material (20) coated onto one or more portions of said surfaces (11) of said transparent means (10) wherein modifications to said luminescent material (20) are not intentionally introduced with the purpose of inducing visible light scattering;
one or more excitation sources (30) able to generate electromagnetic radiation (31) having a suitable spectrum for exciting said luminescent substance (20) and allowing for the transition of said switchable luminescent system from the off-state to the on-state.

2. A switchable luminescent system, as recited in claim 1, characterized in that said transparent means (10) is a monolithic glass sheet or item, a polymer, a plastic material, a glass-ceramic material, or a combination thereof such that they make an heterogeneous transparent material, preferably a laminated material or a double glazed windows.

3. A switchable luminescent system, as recited in claim 1, characterized in that said luminescent material (20) contains one or more luminescent or fluorescent substances (21) having different excitation and emission spectra, preferably comprising phosphors, nanoparticles, quantum dots, transition-metals complexes or other organic or inorganic luminophor substance, and said luminescent or fluorescent substances (21) must have size that do not significantly induce the diffusion of visible light,

4. A switchable luminescent system, as recited in the preceding claim, wherein said luminescent or fluorescent substances (21) are characterized by an absorption spectrum as low as possible in the visible region to avoid a visible coloring of said luminescent material (20) in the off-state.

5. A switchable luminescent system, as recited in one or more of the preceding claims, characterized in that said one or more luminescent or fluorescent substances (21) are dispersed in a transparent organic or inorganic matrix (22).

6. A switchable luminescent system, as recited in one or more of the preceding claims, characterized in that said luminescent or fluorescent substances (21) is in the form of a luminescent o fluorescent varnish or ink or a inorganic coating or a polymeric film.

7. A switchable luminescent system, as recited in claim 1, characterized in that said one or more excitation sources (30) are preferably LED, lasers, neon light sources, discharge lamps, transparent window frame with integrated LED or other point-like or diffuse luminous sources having any continuous or discrete emission spectrum, preferably in the high-energy tail of the visible spectrum (or the near UV region), and able to induce fluorescence, phosphorescence or other luminescence processes in said luminescent material (20) wherein the maximum excitation wavelength 1₁ is less than maximum emission wavelength 1₂ .

8. A switchable luminescent system, as recited in one or more of the preceding claims, characterized in that said one or more excitation sources (30) are placed in such a way that said electromagnetic radiation (31) propagates as a light beam within said transparent means (10), said transparent means (10) being highly transparent to said exciting electromagnetic radiation (31).

9. A switchable luminescent system, as recited in claim 8, characterized in that said transparent means (10) is a plane or curved sheet and said electromagnetic radiation (31) is injected in the transparent means (10) from the edges (13) i.e. in the configuration named ‘edge light injection’.

10. A switchable luminescent system, as recited in claim 8, characterized in that said transparent means (10) is a plane or curved sheet and said electromagnetic radiation (31) is injected laterally in the transparent means (10) by means of a transparent wedge (15), coupled to one or more surfaces (11) of said means (10), i.e. in the configuration named ‘side light injection’, in such a way that luminescence to existing in-place structures can be given.

11. A switchable luminescent system, as recited in one or more of the preceding claims, characterized by a combination of a plurality of luminescent system in ‘edge light injection’, ‘side light injection’ or others configurations and wherein said switchable luminescent system comprises reflecting surfaces attached to one or more of said surfaces (11), provided that said reflecting surfaces not change the see-through characteristic of said switchable luminescent system in the off-state.

12. A switchable luminescent system, as recited in one or more of the preceding claims, wherein said luminescent material (20) is preferably coated by means of roto-offset printing, rotogravure printing, lithography, flexography, tampography, serigraphy, ink-jet, laser, additive manufacturing, hot printing, lenticular printing, thermal transfer, by means of adhesive films or transferable or lamination and any other printing or varnishing processes; thin film deposition techniques, preferably, CVD, PECVD, MOCVD, dip-coating, spin-coating roll-coating, air-knife coating, spray-pyrolysis; powder varnishing, dry-offset, xerography, or other technically equivalent methods for dry printing.

13. A switchable luminescent system, as recited in one or more of the preceding claims, characterized in that said luminescent material (20) is a suitable formulation that allows for the removal of said luminescent material (20), by means of chemical solvent or mechanical means without damaging the portions of the surfaces (11) where said luminescent material (20) is coated or attached thereto.

14. A switchable luminescent system, as recited in one or more of the preceding claims, characterized in that said portions of the surfaces (11) are excited selectively by said plurality of excitation sources (30), by means of a suitable programmable controller, in order to allows for a dynamic visual communication, adaptable accordingly to the situation said luminescent system is placed whereto.

15. A switchable luminescent system, as recited in one or more of the preceding claims, characterized by what is described and showed with reference to the attached invention drawings.
